(19) United States
(12) Patent Application Publication
(10) Pub. No.: US 2025/0353980 A1
(43) Pub. Date: Nov. 20, 2025

(54) HIGH BARRIER COMPOSTABLE PRODUCTS USING PROTEIN FILLERS IN BIOPLASTICS AND METHODS OF MAKING THOSE

(71) Applicant: University of Guelph, Guelph (CA)

(72) Inventors: Amar MOHANTY, Guelph (CA); Manjusri MISRA, Guelph (CA); Akhilesh PAL, Guelph (CA); Arturo RODRIGUEZ-URIBE, Guelph (CA); Shjoadin JAMHA, Guelph (CA)

(73) Assignee: University of Guelph, Guelph, ON (CA)

(21) Appl. No.: 19/208,348

(22) Filed: May 14, 2025

Related U.S. Application Data
(60) Provisional application No. 63/647,559, filed on May 14, 2024.

(51) Int. Cl. C08J 5/18; B65D 65/46; B65D 85/804; C08K 3/013; C08K 3/34

(52) U.S. Cl. CPC C08J 5/18; B65D 65/466; B65D 85/8046; C08K 3/013; C08K 3/346; B65D 2565/387; C08J 2300/16; C08J 2367/02; C08K 2201/008

(57) ABSTRACT

A gas barrier substrate comprising a biodegradable composite, the biodegradable composite comprising a polymeric matrix and a sustainable filler comprising protein. Also articles of manufacture comprising the gas barrier substrate and methods of limiting gas permeation using the gas barrier substrate.

### CROSS REFERENCE TO RELATED APPLICATIONS

This application claims the benefit under 35 U.S.C. 119 (e) of U.S. Provisional Ser. No. 63/647,559, filed May 14, 2024, the contents of which are hereby incorporated by reference into the present disclosure.

### FIELD OF TECHNOLOGY

The technical field of the present disclosure is related to polymer processing and testing technologies. More in specific, herein are described the methods and materials used to develop bio-based polymeric thermoplastic materials or bio-based thermoplastics which milk protein products and byproducts like whey and casein among others are utilized to improve the barrier and overall mechanical and physical performance of common biobased plastics and products which present limited applications their pure form.

### BACKGROUND INFORMATION

Milk is composed of proteins (˜2-5%). The most part of the proteins consist of casein (˜80%) and whey (˜20%). Milk protein concentrate can reach up to 90% protein. These materials are frequently discarded when contaminated with bacterial or produced in large quantities after the production of yogurt (mostly Greek type) or cheese. These byproducts are disposed without control to effluents or released into the soil producing large environmental damage. Thus, it is urgent the recovery and revalorization of milk proteins.

The products described herein are intended for the packaging of food and non-food items which normally require barrier properties as well as acceptable and/or variable physical and mechanical performance. The share of non-biodegradable and non-recyclable plastics in the packaging sector is constantly increasing and with that the burden of an increasing problem in the waste accumulation and disposal. The product(s) described herein are an effort to contribute to the reduction of such non-biodegradable and non-recyclable packaging wastes.

Packaging market requires multi-functional properties related to barrier, mechanical, and physical acceptable performances depending on the final application.

These demands may require one or more of the following: optimal oxygen, water, water vapor, and/or carbon dioxide (CO₂) protection. Acceptable mechanical performance according to the packaging needs, acceptable physical characteristics according to the packaging needs such as density, optical, and the like.

In order to reduce the environmental burden of synthetic plastics accumulation the use of renewable, biobased, biodegradable, compostable, home compostable, and/or reusable materials are practical alternatives. The presence of these materials is increasingly influencing the new technologies, the market price, and legislation around the world.

The current existing plastics, as current main feedstocks for their use in packaging most of the time cannot meet the requirements imposed by the industry, especially in terms of barrier performance. Materials are in constant improvement. However, the main limitation in packaging developed materials is the cost.

The previous literature describing packaging materials made from renewable raw materials with biodegradability properties present unsuitable barrier performance, high cost, unsuitable mechanical performance. Up to date, the different examples on renewable raw materials such as starch of protein-based materials cannot be manufactured or practically applied either due to one or more of the reasons as previously described.

Similar to starch, proteins in especial casein are susceptible to be plasticized in the presence of water or other suitable plasticizers such as glycerol as proteins originally exist in colloidal suspension (micelle). The main requirement is to form hydrogen bonding with casein. Thus, proteins can be plasticized and coextruded in the presence of other phases such as polymeric materials.

Patent application US20140373748A1 describes the process of preparation of hydrogels by plasticizing milk protein products by using common plasticizers such as water and glycerol at temperatures that go from room temperature up to 140° C. The document does not suggest the use of milk proteins within composites to effect barrier properties.

The German Patent DE202004004732U1 describes the manufacture of a multi-layered plastic film useful for sausage casings constructed by at least two edible layers of casein-based product and a gel-like layer. An external synthetic layer must be removed before eating it. An extra step includes the swelling of the casein product for various hours before processing it into pellets and further processing by blown filming. The document does not suggest the use of milk proteins within composites to effect barrier properties.

The patent application US20210381130A1 describes the use of ultra purified milk protein byproducts such as casein or whey to be used in poly (lactic acid) (PLA) for the manufacture of strands to be used in 3D printing. This publication is specific to the creation of homogenous dispersions of purified milk proteins.

The patent application US20230192983 describes compostable barrier packaging made using biocarbon to achieve strong barrier properties. The application does not describe or suggest the use of dairy proteins nor any protein as being useful to create barrier packaging. Additional and variable means of providing barrier properties are needed to give additional options to processors based on, for example, price, function, processability and color of the barrier packaging.

### SUMMARY OF THE DISCLOSURE

The present invention covers fundamental aspects of packaging materials requirements such as high barrier properties, low cost, easy implementation of the products, easy manufacture of the products. The Technology for processing these materials is common to the plastics processing art and thus there is no need to create new technologies. Raw materials can be blended, mixed, and converted into pellets which can be easily manipulated for further processing for injection molding and the like.

The manufacture of the related milk protein byproducts described in the present disclosure as composites require the aid of biodegradable polyesters such as poly(butylene adipate terephthalate), poly(butylene succinate), bio-poly(butylene succinate), poly butylene succinate adipate, bio poly butylene succinate adipate, cellulose acetate, and the like. Poly(3-hydroxybutyrate-co-3-hydroxyvalerate), and the like.

In one embodiment, the present disclosure provides for a gas barrier substrate. In one embodiment, the gas barrier substrate of the present disclosure comprises a biodegradable composite, the biodegradable composite comprising a polymeric matrix and a sustainable filler comprising protein.

In one embodiment of the gas barrier substrate of the present disclosure, the biodegradable composite has an oxygen transmission rate of 55 cc/m2-day or less, or an oxygen transmission rate of 5.96 cc/pkg·day or less, or an oxygen transmission rate of 0.031 cc/pkg·day or less, or an oxygen transmission rate of 0.013 cc/pkg·day or less, or an oxygen transmission rate of 0.009 cc/pkg·day or less, or an oxygen transmission rate of 0.003 cc/pkg·day or less, wherein the oxygen transmission rate is calculated at normalized thickness of the biodegradable composite of 25.4 micrometer (1 mil) at 0% relative humidity, 23.7° C.

In another embodiment of the gas barrier substrate of the present disclosure, the biodegradable composite has a water permeation rate of 0.033 g/pkg·day, or less or has a water permeation rate of 0.02 g/pkg·day or less, or a water permeation rate of 0.016 g/pkg·day or less, wherein the water permeation rate is calculated at normalized thickness of the biodegradable composite of 25.4 micrometer (1 mil) at 100% relative humidity, 37.8° C.

In another embodiment of the gas barrier substrate of the present disclosure, the polymeric matrix comprises one or more biodegradable polymers.

In another embodiment of the gas barrier substrate of the present disclosure, the polymer matrix comprises one or more of polylactide (PLA), Bio-based poly(butylene succinate) (BioPBS), poly(butylene succinate adipate) (PBSA), poly(butylene adipate-co-terephthalate) (PBAT), polycaprolactone (PCL), polyhydroxyalkanoates (PHAs) including poly(3-hydroxy) butyrate (PHB) and poly(3-hydroxybutyrate-hydroxyvalerate) (PHBV).

In another embodiment of the gas barrier substrate of the present disclosure, the polymeric matrix comprises a binary blend of PHBV/PBAT, BioPBS/PLA, or a ternary blend of PHBV/PBAT/PBSA.

In another embodiment of the gas barrier substrate of the present disclosure, the polymeric matrix comprises PHBV, BioPBS, PBSA, PBAT, PCL or PLA as a major component of the polymeric matrix.

In another embodiment of the gas barrier substrate of the present disclosure, the biodegradable composite is free of ethylene vinyl alcohol (EVOH) or polyvinyl alcohol (PVOH).

In another embodiment of the gas barrier substrate of the present disclosure, the sustainable filler is a hybrid filler comprising (a) milk protein and/or soy protein and (b) a second filler selected from one or more of: starch; inorganic mineral fillers from talc, clay and/or wollastonite.

In another embodiment of the gas barrier substrate of the present disclosure, the biodegradable composite comprises up to 25 wt % of sustainable fillers.

In another embodiment of the gas barrier substrate of the present disclosure, the oxygen transmission rate of the gas barrier substrate is similar or lower than the oxygen transmission rate of each one of PET, Nylon or EVOH.

In another embodiment of the gas barrier substrate of the present disclosure, the biodegradable composite further comprises a compatibilizer, the compatibilizer including peroxide or maleic anhydride-grafted biopolymers.

In another embodiment of the gas barrier substrate of the present disclosure, the gas barrier substrate is industrial compostable or home compostable.

In another embodiment of the gas barrier substrate of the present disclosure, the gas barrier substrate is a single layer gas barrier.

In another embodiment of the gas barrier substrate of the present disclosure, the gas barrier substrate is in the form of a pellet, a granule, an extruded solid, an injection molding solid.

In another embodiment, the present disclosure provides for an article of manufacture comprising the gas barrier substrate of the present disclosure.

In one embodiment, the article of manufacture is a film, sheet, membrane, injection molded or thermoformed shapes.

In another embodiment, the article of manufacture a packaging in the shape of a coffee pod.

In one embodiment, the present disclosure relates to a method of limiting gas permeation through a membrane, the method comprising at least partially or entirely manufacturing the membrane with the gas barrier substrate of the present disclosure.

In one embodiment of the method of limiting gas permeation through a membrane of the present disclosure, the membrane is in the form of a container.

### BRIEF DESCRIPTION OF THE DRAWINGS

The following figures illustrate various aspects of the embodiments of the present invention.

FIG. 1: Photograph of injection molded Espresso type (wall thickness: 0.45 mm) pods prepared using non-biodegradable EVOH.

FIGS. 2A-2D: Photographs of injection molded (2A) Keurig type (wall thickness: 0.6 mm), (2B) Espresso type (wall thickness: 0.6 mm) pods prepared using polymer composite having soy protein isolate as one of the fillers and (2C) Keurig type (wall thickness: 0.6 mm), (2D) Espresso type (wall thickness: 0.6 mm) pods prepared using polymer composite having milk protein concentrate as one of the fillers.

FIGS. 3A-3B: Photographs of (3A) Keurig type pod using biocomposite with milk protein concentrate sealed over flat plate (up-side down) and (3B) sealed Keurig type pod using biocomposite with milk protein concentrate kept in environmental chamber for oxygen transmission testing.

### DETAILED DISCLOSURE

### Definitions

Unless defined otherwise, all the scientific and technical terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated, or the context clearly indicates otherwise (for example, “including”, “having”, “such as” and “comprising” typically indicate “including without limitation”). Singular forms included in the claims such as “a”, “an” and “the” include the plural reference unless expressly stated otherwise. All relevant references, including patents, patent applications, government publications, government regulations, and academic literature, are hereinafter detailed and incorporated by reference in their entireties. In order to aid the understanding of the invention, the following illustrative, non-limiting, examples are provided.

In this specification and in the claims that follow, reference will be made to a number of terms that shall be defined to have the meanings below. All numerical designations, e.g., temperatures, concentrations, dimensions, and weight, including ranges, are approximations that typically may be varied (+) or (−) by increments of 0.1, 1.0, or 10.0, as appropriate. All numerical designations may be understood as preceded by the term “about”. As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above.

The term “about”, as used herein, modifying any amount refers to the variation in that amount encountered in real-world conditions of producing materials such as polymers or composite materials, e.g., in the lab, pilot plant, or production facility. For example, an ingredient employed in a mixture when modified by about includes the variation and degree of care typically employed in measuring in a plant or lab producing material or polymer. For example, the amount of a product component when modified by about includes the variation between batches in a plant or lab and the variation inherent in the analytical method. Whether or not modified by about, the amounts include equivalents to those amounts. Any quantity stated herein and modified by “about” can also be employed in the present invention as the amount not modified by about.

The term “comprising”, as used herein, means any recited elements are necessarily included and other elements may optionally be included. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

The prefix “bio-”, as used herein, is used in this document to designate a material that has been derived from a biological/renewable resource.

The term “renewable resource and/or renewable material and/or renewable polymer”, as used herein, refers to a resource that is produced by a natural process at a rate comparable to its rate of consumption (e.g., within a 100-year time frame). The resource can be replenished naturally, or via agricultural techniques.

The term “biodegradable” refers to a material being prone to be broken down by the biological action of naturally occurring microorganisms such as fungi and bacteria.

The term “compostable”, as used herein, refers to a material being prone to be broken down into water, carbon dioxide, and biomass by microorganisms in a compost, which can be a decomposing mass of plant, manure, and other organic waste. The term “compostable” can include “industrially compostable” and “home compostable”. The term “industrially compostable” means that the material satisfies the requirements set by ASTM D6400 Standard Specification for Labeling of Plastics Designed to be Aerobically Composted in Municipal or Industrial Facilities. The term “home compostable” refers to a material satisfying the requirements set by the standards NF T 51-800—Specifications for Plastics Suitable for Home Composting or AS 5810-Biodegradable Plastics Suitable for Home Composting.

The term “biobased content”, as used herein, refers to the percentage by weight of a material that is composed of biological products or renewable agricultural materials or forestry materials or an intermediate feedstock.

The term “fillers”, as used herein, refers to the combination of two or more fillers that can be organic or inorganic and be either physically or chemically different.

The term “amino acid residue” is known in the art. In general the abbreviations used herein for designating the amino acids and the protective groups are based on recommendations of the IUPAC-IUB Commission on Biochemical Nomenclature (see Biochemistry (1972) 11:1726-1732). In certain embodiments, the amino acids used in the application of this disclosure are those naturally occurring amino acids found in proteins, or the naturally occurring anabolic or catabolic products of such amino acids which contain amino and carboxyl groups. Particularly suitable amino acid side chains include side chains selected from those of the following amino acids: glycine, alanine, valine, cysteine, leucine, isoleucine, serine, threonine, methionine, glutamic acid, aspartic acid, glutamine, asparagine, lysine, arginine, proline, histidine, phenylalanine, tyrosine, and tryptophan. In certain embodiment, the amino acids used in the application of this disclosure include analogs, derivatives and congeners of any specific amino acid referred to herein, as well as C-terminal or N-terminal protected amino acid derivatives (e.g. modified with an N-terminal or C-terminal protecting group) as well as unnatural amino acids.

The term “protein” is known in the art. In general it refers to a chain of amino acid residues. In this document the term “protein,” “polypeptide’ and “peptide” are used interchangeably. The proteins of the present disclosure, can have a variety of lengths. A protein of the present disclosure can have, for example, a relatively short length of at least 2 residues, including 2, 3, 4, 5, 6, 7, 8, 9, 10, 11, 12, 13, 14, 15, 16, 17, 18, 19, 20 and so forth residues. A protein of the present disclosure also can be useful in the context of a significantly longer sequences, such as at least 20 amino acid residues. In one embodiment, the protein of the present disclosure are naturally occurring proteins. In another embodiment, the proteins of the present disclosure are synthetic or artificial proteins. In another embodiment, the proteins are unmodified (i.e. have not undergone chemical alterations).

“Isolated” or “isolate” refers to a protein which is substantially separated from other cellular components.

The term “unnatural” refers in this document to amino acids not naturally encoded or found in the genetic code of any organisms.

The term “wt. %”, as used herein, refers to the weight percent of a component with respect to the weight of the whole composition.

The term “phr”, as used herein, is parts per hundred resins. It denotes the mass proportion of an additive with respect to one hundred parts of the resin, which can be a polymer, a polymer blend and a polymer composite.

The term “Thermoplastic”, as used herein, refers to a material, such as a polymer, which softens (e.g., becomes moldable or pliable) when heated and hardens when cooled.

The term “Composite”, as used herein, generally means a combination of two or more distinct materials, each of which retains its own distinctive properties, to create a new material with properties that cannot be achieved by any of the components acting alone.

The term “Micron-Size” refers to the average size of fillers particle in the range of 1 μm to 10 μm.

The term “Talc”, as used herein, refers to a clay mineral in the powder form, composed of hydrated/non-hydrated magnesium/aluminum silicates. In one embodiment, the term “talc” refers to unmodified (chemically or otherwise) clay mineral in powder form.

The term “Free Radical Initiator”, as used herein, refers to substances that can produce radical species under mild conditions and promote radical reactions. Non-limiting examples of “free radical initiators” that can be used in the present invention include: dibenzoyl peroxide, benzoyl peroxide, 2,5-dimethyl-2,5-di(t-butylperoxy) 3-hexyne and dicumyl peroxide, including but not limited to: 2,5-bis(tert-butylperoxy)-2,5-dimethylhexane; 2,5-dimethyl-2,5-di(t-butylperoxy) hexane; 2,5-dimethyl-2,5-di(t-amylperoxy) hexane; 4-(t-butylperoxy)-4-methyl-2-pentanol; Bis(t-butylperoxyisopropyl)benzene; 3,6,9-Trirthyl-3,6,9-Trimethyl-1,4,7-Triperoxonane; Ethyl 3,3-bis(t-butylperoxy) butyrate; Ethyl 3,3-bis(t-amylperoxy) butyrate; and tert.butylperoxy-3,5,5-trimethylhexanoate, or similar compounds.

The term “Chain Extender”, as used herein, refers to substances that multi-functional reactive polymer with an improved thermal stability. It can also be used for the modification of thermoplastics.

The term “one-step extrusion”, as used herein, refers to a conventional hot melt-extrusion process in which heat and pressure are applied to melt a polymer/polymer mixture and forcing it through an orifice in a continuous process.

The term “Melt flow index” or “MFI”, as used herein, refers to the measurement of the flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures. The method is described in the standard ASTM D1238-23 and similar.

The term “HDT” is “heat deflection temperature” or “heat distortion temperature” (HDT), which are used interchangeably. It refers to the temperature at which a polymer object deforms under a specified load. The HDT is determined by the following test procedure outlined in ASTM D648. The test specimen is loaded in three-point bending in the edgewise direction. The two most common loads are 0.455 MPa or 1.82 MPa and the temperature is increased at 2° C./min until the specimen deflects 250 μm.

The term “barrier” refers to the property of blocking or impeding the permeation of gas or water vapor molecules. It is evaluated by measuring the transmission rate at specified conditions of temperature, relative humidity, and pressure.

The term “Mechanical and thermal properties”, as used herein, refers to tensile and flexural properties, impact strength, and heat deflection temperature (HDT). Methods that can be used to assess the performance of plastics are described in the following standards:
(a) ASTM standard D638-22; Standard Test Method for Tensile Properties of Plastics.
(b) ASTM standard D790-17; Standard Test Method for Flexural Properties of Unreinforced and Reinforced Plastics and Electrical Insulating Materials.
(c) ASTM standard D256-23el; Standard Test Methods for Determining the Izod Pendulum Impact Resistance of Plastics.
(d) ASTM standard D648-18; Standard Test Method for Deflection Temperature of Plastics Under Flexural Load in the Edgewise Position.
(e) ASTM standard F1927-20; Standard Test Method for Determination of Oxygen Gas Transmission Rate, Permeability and Permeance at Controlled Relative Humidity Through Barrier Materials Using a Coulometric Detector.
(f) ASTM standard F1249-20; Standard Test Method for Water Vapor Transmission Rate Through Plastic Film and Sheeting Using a Modulated Infrared Sensor.
(g) Other standards may be followed, like ASTM standard D618-21; Standard Practice for Conditioning Plastics for Testing.

When not specified, other certifications and/or standards can be used and adopted.

In the context of the present disclosure, “a major component of the polymeric matrix” means 20 wt. % or more of the polymeric matrix, preferably 40 wt. % or more of the polymeric matrix.

### DETAILED DESCRIPTION

From now on, this document provides detailed description of the embodiments of the present disclosure.

The present disclosure describes thermoplastic materials including biodegradable and compostable thermoplastics which are reinforced with renewable protein-based products or by-products such as milk protein and the like and methods to produce them. In embodiments, the milk derived products of the present disclosure in the presence of plastics and bioplastics can be processed up to temperatures of 180° C. and be subjected to preparation methods known to a person skilled in the art of polymer processing which include extrusion or melt blending followed by injection molding, thermoforming, compression molding, and the like. The resulting materials present high barrier properties and overall physical and mechanical performance as well as biodegradability and/or compostability which allow them to be used in sectors related to packaging and the like.

As such, in one embodiment, the present disclosure provides for a gas barrier substrate, wherein the gas barrier substrate comprises a biodegradable composite, the biodegradable composite comprising a polymeric matrix and a protein. In one embodiment, the protein is provided as part of a sustainable filler. In one embodiment, the protein is a milk protein and/or a soy protein.

In one embodiment, the biodegradable composite has an oxygen transmission rate of 55 cc/m2-day or less, or an oxygen transmission rate of 5.96 cc/pkg·day or less, or an oxygen transmission rate of 0.031 cc/pkg·day or less, or an oxygen transmission rate of 0.013 cc/pkg·day or less, or an oxygen transmission rate of 0.009 cc/pkg·day or less, or an oxygen transmission rate of 0.003 cc/pkg·day or less, wherein the oxygen transmission rate is calculated at normalized thickness of the biodegradable composite of 25.4 micrometer (1 mil) at 0% relative humidity, 23.7° C.

In another embodiment, the biodegradable composite has a water permeation rate of 0.033 g/pkg·day, or less or has a water permeation rate of 0.02 g/pkg·day or less, or a water permeation rate of 0.016 g/pkg·day or less, wherein the water permeation rate is calculated at normalized thickness of the biodegradable composite of 25.4 micrometer (1 mil) at 100% relative humidity, 37.8° C.

In one embodiment of the gas barrier substrate of the present disclosure, the polymer matrix comprises one or more of polylactide (PLA), Bio-based poly(butylene succinate) (BioPBS), poly(butylene succinate adipate) (PBSA), poly(butylene adipate-co-terephthalate) (PBAT), polycaprolactone (PCL), polyhydroxyalkanoates (PHAs) including poly(3-hydroxy) butyrate (PHB) and poly(3-hydroxybutyrate-hydroxyvalerate) (PHBV).

In another embodiment, the polymeric matrix comprises a binary blend of PHBV/PBAT, BioPBS/PLA, or a ternary blend of PHBV/PBAT/PBSA.

In another embodiment of the present disclosure, the polymeric matrix comprises PHBV, BioPBS, PBSA, PBAT, PCL or PLA as a major component of the polymeric matrix.

In one embodiment, the present disclosure provides a biodegradable matrix composed of biodegradable thermoplastics and their binary or ternary blends that are reinforced with the fillers (single, binary or ternary fillers) and which may be produced by reactive extrusion suitable for general purpose application such as food containers/packaging and the like that require excellent barrier performance. The host polymer can be one biodegradable polymer itself such as PHBV, or binary blends (e.g., PHBV/Ecoflex®, PHBV/PBSA), ternary blends (e.g., PHBV/PBSA/Ecoflex®). The other combination of host polymers can be one biodegradable polymer itself such as BioPBS, or binary blends (e.g., BioPBS/PLA).

In embodiments, the composites of the present disclosure can be compounded in one-step extrusion in which bioplastics, additives, compatibilizers and fillers are mixed together and are added in a main feeder. Injection molding was used in the synthetic plastic industries, may also be used in the method of processing.

In embodiments, biodegradable biocomposites with a high oxygen barrier have been obtained in which the oxygen permeation was comparable to or lower than known high oxygen barrier petroleum-based polymers e.g., EVOH. Such filler systems can be engineered without any pre- or post-treatment of the filler components, thus making the whole technology cost competitive. The resulting formulation of the present invention with sustainable fillers can be tailored for film/sheet or injection molding for biodegradable (compostable) as well as high barrier packaging applications.

The present biocomposites with protein/proteins exhibit excellent oxygen barrier properties similar to or superior to petroleum-based polymers, e.g., poly(ethylene terephthalate) (PET), polyvinyl chloride (PVC) and EVOH. The present biocomposites with milk protein concentrate-based fillers exhibit high oxygen barrier properties similar to or superior to polystyrene (PS) and Nylon-6.

The present biocomposites may be formed into useful articles using any of a variety of conventional methods for forming items from plastic. The present biocomposites may make any of a variety of packaging articles like tray, film or containers.

In embodiments of the invention, the biodegradable composites composition comprises a biodegradable polymer/polymer blend, a compatibilizer/a combination of compatibilizers, an additive (including but not limited to organic peroxide and chain extender), waxes (including but not limited to biodegradable waxes), proteins (including but not limited to milk protein concentrates) and other fillers (including organic and inorganic fillers) and can have tunable melt flow properties.

Organic peroxides are organic compounds containing oxygen-oxygen single bonds which are very reactive, and which break easily to give free radicals. Chain extenders react with the ends of polymer chains and increase their overall molecular weight to avoid any thermal decomposition of polymer chains.

In some embodiments of the invention, the used polymers are materials commonly found in the market and are biodegradable and compostable.

In some embodiments, the fillers can be chosen from raw/post-industrial milk protein concentrates and other protein-based dairy byproducts.

In some embodiments, the fillers can be chosen from talc, clay, wollastonite, and other mineral fillers.

In some embodiments, the fillers can be chosen from starch/post-industrial starch and other similar organic fillers.

In some embodiments, the additives can be chosen from biodegradable waxes and other similar fatty acids.

In some embodiments, the polymer/polymer blend matrix composition comprises up to 25 wt. % fillers.

In some embodiments, the filler particles act as effective carriers of organic peroxide.

In some embodiments, the method enables the preparation of anhydride grafted compatibilizers.

In embodiments, the polymer composites compositions are biodegradable, including in industrial and home composting facilities. In embodiments, the term “compostable” can include “industrially compostable” and “home compostable”. The term “industrially compostable” means that the material satisfies the requirements set by ASTM D6400 Standard Specification for Labeling of Plastics Designed to be Aerobically Composted in Municipal or Industrial Facilities. The term “home compostable” refers to a material satisfying the requirements set by the standards NF T 51-800—Specifications for Plastics Suitable for Home Composting or AS 5810-Biodegradable Plastics Suitable for Home Composting.

In some embodiments, the polymer composites composition can be molded into plastic articles.

In some embodiments, the single-use plastic article is rigid container or packaging, e.g., coffee pods.

In some embodiments, the polymer composite compositions have an oxygen transmission rate of 0.036 cc/pkg·day or less, or an oxygen transmission rate of 0.020 cc/pkg·day or less, or an oxygen transmission rate of 0.013 cc/pkg·day or less, or an oxygen transmission rate of 0.006 cc/pkg·day or less, or an oxygen transmission rate of 0.002 cc/pkg·day or less, wherein the oxygen transmission rate is calculated at a normalized thickness of the biodegradable composite of 0.66 mm at 0% relative humidity (RH), 23.7° C.

In another embodiment, the present disclosure provides for a method of improving the storage life of goods, the method comprising at least partially or entirely covering the goods with a gas barrier substrate of the present disclosure. In one embodiment, the goods are perishables, such as foodstuffs.

In another embodiment, the present disclosure relates to a method of limiting gas permeation through a membrane, the method comprising at least partially or entirely manufacturing the membrane with the gas barrier substrate of the present disclosure. In one embodiment the membrane is in the form of a container or package.

### Examples

The non-limiting examples below are provided to illustrate the embodiments of the disclosure and not limit the scope of the disclosure. Other aspects, applications, advantages, and modifications within the scope of the disclosure will be apparent to those skilled in the art.

The materials and general methods are given below, with specific examples following.

### Materials

The information on the materials used in all examples is summarized in Table 1. The polymer matrix of the compositions is biodegradable polymers. Various types of additives such as organic peroxide and chain extenders are used. The filler system includes mineral fillers including but not limited to talc and wollastonite, and organic materials including but not limited to milk protein concentrates, soy protein isolates and starch. The size of the talc used is on the micron level (700 nm to 5 μm).

TABLE 1
Materials used in the presented examples.

| | | Grade or Trade | |
|---|---|---|---|
| Materials | Name | Name | Supplier |
| Petroleum- | EVOH | — | Donated by Competitive |
| based | | | Green Technologies, Canada |
| Polymer | | | |
| [Reference | | | |
| Material] | | | |
| Biodegradable | PHBV | ENMAT | Xinjiang Blue Ridge Tunhe |
| polymer | | Y1000P | Sci. & Tech. Co. Ltd., China |
| | PBSA | TH802A | Sichuan Push Acetati Co., |
| | | | Ltd., China |
| | BioPBSA | FD92PM | PTT MCC Biochem |
| | | | Company Limited, Thailand |
| | Ecoflex ® (a copolyester | F Blend C1200 | BASF |
| | of the monomers 1.4- | | |
| | butanediol, adipic acid | | |
| | and terephthalic acid) | | |
| | PLA | Ingeo ™ 3251D | Natureworks, US |
| | BioPBS | TH803S-BioD | Xinjiang Blue Ridge Tunhe |
| | | | Sci. & Tech. Co. Ltd., China |
| | PBAT | — | Technipol Thermoplastic |
| | | | Adhesives, donated by CG |
| | | | Tech |
| Additive | 2,5-dimethyl-2,5-di(tert- | Luperox ® 101 | Sigma Aldrich, Canada |
| | butylperoxy)-hexane | | |
| Mineral fillers | Talc [size: ~800 nm] | FortiTalc ® AG | Minerals Technologies Inc., |
| | | 609 | USA |
| | Wollastonite | — | China |
| Organic fillers | Corn Starch | Post-industrial | Donated by Competitive |
| | | | Green Technologies, Canada |
| | Milk Protein Concentrate | — | Gay Lea Foods Co Ltd. |
| | (77-89%) | | |
| | Soy Protein Isolate | — | Archer-Daniels-Midland |
| | | | Company (ADM), Decatur, |
| | | | Illinois |
| | Wax | TopScreen ™M | SOLENIS, US |
| | | ED 9 Biowax | |

### Methods

The polymer matrix can be a single biodegradable polymer or the binary/ternary polymer blends selected from but not limited to PLA, BioPBS, PHBV, PBSA, Bio-PBSA, PBAT, Ecoflex® and alike. In the examples provided in this invention, all the polymers mentioned in Table 1 are used here.

### Melt Extrusion

All the mentioned formulations mixture were melt compounded at 170-200° C. in a twin-screw extruder (Leistritz Micro-27, Nurnberg, Germany) equipped with screws with a diameter of 27 mm and an L/D ratio of 48. The feeding rate and screw speed were 5-10 kg/h and 100 rpm, respectively. The extruded strands were pelletized and dried in a hot-air oven overnight. The processing conditions are listed in Table 2.

TABLE 2
Extrusion parameters, fillers and additive
percentages used in the invention.

| Parameters | Conditions | |
|---|---|---|
| Processing temperature | 170 to 200° | C. |
| Feed rate | 5-10 | kg/h |
| Screw speed | 60-150 | rpm |
| Residence time | 0.2-5 | min |

### Compatibilizer Preparation by Melt-Extrusion

The blends can be compatibilized in the presence of low contents of free radicals including but not limited to dibenzoyl peroxide, benzoyl peroxide and dicumyl peroxide, 2,5-dimethyl-2,5-di(t-butylperoxy) 3-hexyne; 4-(t-butylperoxy)-4-methyl-2-pentanol; Bis(t˜butylperoxyisopropyl)benzene; Dicumyl peroxide; Ethyl 3,3-bis(t-butylperoxy) butyrate; Ethyl 3,3-bis(t-amylperoxy) butyrate; and, Dibenzoyl peroxide.

To prepare maleic anhydride-grafted-polymer (MA-g-Polymer), the initiator (less or equal to 1 phr) can be dissolved in acetone (less or equal to 5 ml) and coated over pre-dried polymer pellets. The powdered MA (less, equal or more than 5 wt %) was added into the above-mentioned coated polymer pellets and mixed manually so that MA can uniformly adhere over the coated pellets. The prepared mixture was fed into a co-rotating twin screw extruder (Micro-27, Leistritz advance technologies corporation, USA), operated at 160-180° C. (all zones), 60 rpm (screw speed) and 5 kg/h (feed rate). The fabricated strands were cooled down after passing through a chilled water bath followed by pelletization.

### Injection Molding

The pellets obtained by extrusion were injection molded into specimens for mechanical and thermal property characterizations by using Xplore micro compounder with micro injection molder (Xplore Instruments BV, The Netherlands). The Xplore micro compounder is equipped with twin screws with an L/D ratio of 150:18. The processing temperature, screw speed, and retention time were 170-200° C., 100 rpm and 1 min, respectively. The same temperature (170-200° C.) was set for the transfer device. On the micro injection molder, the filling, packing, and holding pressures were fixed at 7 bar with a holding time of 5 sec. At least five specimens of each type were fabricated. The test specimens were kept at about 50% relative humidity and room temperature for 48 h before being tested. EVOH pellets were also used to produce specimens at temperatures between 200-225° C., screw speed at 100 rpm and 1 min retention time. On the micro injection molder, the filling, packing, and holding pressures were fixed at 10 bar with a holding time of 5 sec. At least five specimens of each type were fabricated.

### Injection Molding of Formed Articles

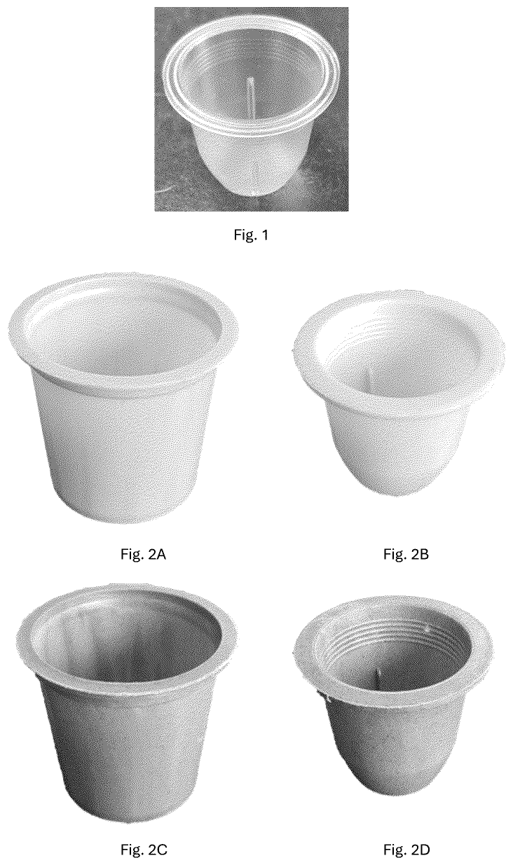

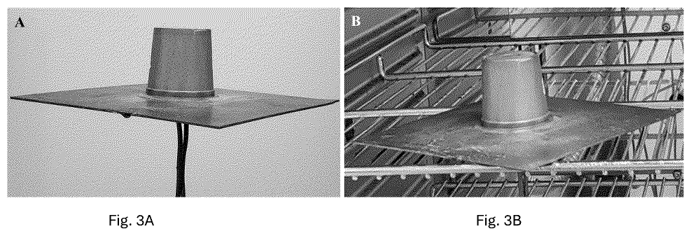

The pellets of the polymer composites obtained by extrusion were injection molded into small containers (specifically coffee pods) by using an ARBURG AllRounder 370 co-injection moulding machine (ARBURG GmbH+Co KG, Loßburg, Germany). Injection molding was performed at temperatures between 180 to 200° C., dosage volume in the range of 30 to 45 cm³, injection pressure in the range of 1200 to 1800 bar, cooling time in the range of 2 to 20 s and cooling temperature in the range of 20 to 35° C. Coffee pods with different sizes and thicknesses were prepared to match the dimensions of the commercial products available in the market (see FIGS. 1 to 3). Based on the unique mold design of the coffee pods, the thickness of the coffee pods was reduced from 0.6 mm to 0.4 mm. EVOH pellets were also used to produce Espresso type pods at temperatures between 190 to 220° C., dosage volume in the range of 30 to 45 cm³, injection pressure in the range of 1200 to 1800 bar, cooling time in the range of 2 to 20 s and cooling temperature in the range of 20 to 35° C.

### Properties Analyses

The melt flow index (MFI) was measured using a melt flow indexer (Qualitest, USA) operated at 190° C. as per ASTM 1238-20. The analysis was repeated three times for each formulation to check the repeatability.

The tensile, flexural and impact specimens were prepared as per ASTM D-638 (type IV), ASTM D-790 and ASTM D-256 standards, respectively. The tensile and flexural properties were measured by using a universal testing machine (Instron 3382) at testing speeds of 5 mm/min and 14 mm/min, respectively. The notched Izod impact strength was tested using a Zwick/Roell HIT25P impact tester equipped with a 2.5 J hammer. Five specimens of each sample type were tested to obtain the average and standard deviation.

The heat deflection temperature (HDT) was measured by using the 3-point bending mode of a Q800 dynamic mechanical analyzer from TA Instruments (New Castle, DE, USA). The heating rate was set at 2° C./min. The HDT was determined as the temperature at which the test bar deflected 0.25 mm (0.01 in) under a flexural load of 0.455 MPa.

The oxygen transmission rate (OTR) of the molded articles was measured using an OX-TRAN 2/22L system (Macon, US) according to ASTM standard D3985. The water vapor transmission rate (WVTR) was measured using a PERMATRAN-W 3/33 system (Mocon, US) as per ASTM standard D6701. In the examples, the testing conditions were 0% relative humidity (RH) and 23.7° C. for OTR, and 90% RH and 37.8° C. for WVTR.

Examples 1-10 deal with PHBV/PBSA/Ecoflex-based composite formulations based on their barrier and mechanical data in Table 3.

EXAMPLE 1 demonstrates the fabrication of Espresso type pods and tensile specimens using non-biodegradable EVOH by injection molding technique. The oxygen and water vapor transmission rates show very low values as 0.0024 cc/Pkg·day and 0.0009 g/Pkg·day, respectively. These values are used as reference values for biocomposite formulations developed in this patent application. The HDT value of EVOH sample was observed as 85.1±6.7° C., which is suitable for hot beverage packages. The tensile modulus, % elongation at break, impact strength and MFI of EVOH were observed as 4345±131 MPa, 3.27±0.24%, 23.23±1.21 J/m and 20 g/10 min, respectively as shown in Table 3.

EXAMPLES 2-3 present the effect of addition of milk protein concentrate (15 wt %) in the presence of talc in the range of 7-10 wt % in PHBV-based composites. Talc is a material used to improve both mechanical and barrier performances. Examples 2-3 show that the fundamental effect of milk protein is to provide excellent barrier performance as compared to other similar materials (i.e., gas/water barrier properties similar to or superior to petroleum-based polymers, e.g., poly(ethylene terephthalate) (PET), polyvinyl chloride (PVC) and EVOH), which is the main objective of this disclosure.

EXAMPLES 4-5 demonstrate that the different types of proteins affect the oxygen barrier properties as well as HDT analysis. The addition of 12.5 wt % milk protein concentrates in the presence of 12.5 wt % talc into the polymer blend matrix improves the oxygen barrier property from 0.031 cc/pkg·day to 0.024 cc/pkg·day. This improvement may be due to the well dispersion of milk protein in the matrix and better interaction with the PHBV and Ecoflex. Similarly, the addition of milk protein concentrates shows significantly improved mechanical properties as compared to the soy protein-based counterpart. The data can be seen in Table 3.

EXAMPLES 6-8 present the effect of addition of protein fillers (milk protein concentrate and soy protein isolate) on the mechanical and barrier properties. It is clearly observed that the addition of milk protein concentrates in the polymer blend matrix show ultra-high oxygen barrier (0.003 cc/pkg·day) as compared to the counterpart with soy protein isolate. Whereas the addition of hybrid fillers [a combination of starch (5 wt %) and milk protein concentrates (7.5 wt %)] show better oxygen barrier properties (0.008 cc/pk·day) as compared to the counterpart with soy protein isolate. In terms of mechanical properties, milk protein isolates show better tensile, flexural and impact properties. The HDT value of milk protein concentrates-based formulation was observed highest (140.4° C.) as compared to examples 6 and 8. Whereas the presence of soy protein isolate in the formulation (in example 6) shows significantly improved MFI as compared to examples 7 and 8. The addition of starch shows hybridization as an alternative to achieve good barrier performance as opposed to only one type of reinforcing bio-filler. Starch from different origins can be added, but most preferably those classified as waste or more exactly post-industrial waste.

EXAMPLES 9-10 demonstrate the effect of addition of silane treated Wollastonite (mineral filler) on the mechanical and barrier properties of PHBV/Ecoflex blend matrix in the presence of talc and milk protein concentrates or soy protein isolate. Example 9 shows that the Wollastonite doesn't interact well with soy protein and matrix. Hence, oxygen barrier property of example 9 was significantly inferior as compared to example 10. The HDT value of Wollastonite and milk protein concentrates-based formulation (example 10) was observed better (134.75° C.) as compared to example 9. Whereas the presence of soy protein isolate in the formulation (in example 9) shows significantly improved MFI as compared to example 10. Different sources of protein perform differently, and hybridization can help in expanding opportunities to use the various resources available.

EXAMPLES 11-16 deal with BioPBS/PLA-based composite formulations based on their barrier and mechanical data in Table 4.

EXAMPLES 11-13 present the effect of organic fillers (soy protein isolate, milk protein concentrates and starch) on the barrier and mechanical properties of BioPBS/PLA-based composite formulations. The highest oxygen barrier properties (0.009 cc/pkg·day) are observed in the case of milk protein concentrates (example 12) as compared to the counterparts with soy protein isolate (example 11) and counterparts with starch (example 13). The composite formulation with soy protein isolate and starch show similar oxygen barrier properties. Whereas starch-based composite show better tensile modulus and MFI as compared to examples 11 and 12. The results presented in examples 11, 12 and 13 clearly illustrate the superior and impactful oxygen barrier properties specific to milk protein concentrate-based formulation.

EXAMPLES 14-16 present the effect of different fillers (milk protein concentrate, soy protein isolate and starch) on the mechanical and barrier properties of BioPBS/PLA-based composite formulations. It is clearly observed that the addition of milk protein concentrates in the polymer blend matrix show ultra-high oxygen barrier (0.009 cc/pkg·day) as compared to the counterpart with soy protein isolate (example 15) and starch (example 14)-based composite. The presence of chain extender in examples 14-16 reduces the mechanical and HDT properties, which suggests that the addition of chain extender increased the amorphous phase in the composites.

In tables 3 and 4, the following headings represent measured material properties:
A. Thickness (mm)
B. Oxygen Transmission Rate (cc/pkg-day); (23° C., 0% RH)
C. Oxygen Permeation (cc·mil/pkg-day); (23° C., 0% RH)
D. Water Vapor Transmission Rate (g/pkg-day); (37.8° C., 90% RH)
E. Water Permeation (g·mil/pkg-day); (37.8° C., 90% RH)
F. Tensile Modulus (MPa)
G. Tensile Strength (MPa)
H. Elongation at Yield (%)
I. Elongation at Break (%)
J. Flexural Modulus (MPa)
K. Flexural Strength (MPa)
L. Impact Strength (J/m)
M. MFI (g/10 min); (190° C., 90% RH)
N. HDT (° C.)

Numbers 1 to 16 in the first column of Tables 3 and 4 represent the following Examples:
Example 1: EVOH
Example 2: 72.5% [60% PHBV/40% (PBSA (injection grade)/Ecoflex® (50/50))]/1.2% MA-g-PHBV/0.4% MA-g-PBSA (injection grade)/0.4% MA-g-Ecoflex/10% Talc (AG609)/15% Milk Protein Concentrate/0.5% Biowax (Wax in Acetone Emulsion)/0.02 Phr Luperox in acetone
Example 3: 75.5% [60% PHBV/40% (PBSA (injection grade)/Ecoflex® (50/50))]/1.2% MA-g-PHBV/0.4% MA-g-PBSA (injection grade)/0.4% MA-g-Ecoflex/7% Talc (AG609)/15% Milk Protein Concentrate/0.5% Biowax (Wax in Acetone Emulsion)/0.02 Phr Luperox in acetone
Example 4: 72.5% [55% PHBV/45% Ecoflex]/1.1% MA-g-PHBV/0.9% MA-g-Ecoflex/12.5% Talc (AG609)/12.5% Soy Protein Isolate/0.5% Biowax (Wax in Acetone Emulsion)/0.02 Phr Luperox in acetone
Example 5: 72.5% [55% PHBV/45% Ecoflex]/1.1% MA-g-PHBV/0.9% MA-g-Ecoflex/12.5% Talc (AG609)/12.5% Milk Protein Concentrate/0.5% Biowax (Wax in Acetone Emulsion)/0.02 Phr Luperox in acetone
Example 6: 72.5% [80% PHBV/20% Ecoflex]/1.6% MA-g-PHBV/0.4% MA-g-Ecoflex/12.5% Talc (AG609)/12.5% Soy Protein Isolate/0.5% Biowax (Wax in Acetone Emulsion)/0.05 Phr Luperox in acetone
Example 7: 72.5% [80% PHBV/20% Ecoflex]/1.6% MA-g-PHBV/0.4% MA-g-Ecoflex/12.5% Talc (AG609)/12.5% Milk Protein Concentrate/0.5% Biowax (Wax in Acetone Emulsion)/0.05 Phr Luperox in acetone
Example 8: 72.5% [80% PHBV/20% Ecoflex]/1.6% MA-g-PHBV/0.4% MA-g-Ecoflex/12.5% Talc (AG609)/7.5% Milk Protein Concentrate/5% Starch/0.5% Biowax (Wax in Acetone Emulsion)/0.05 Phr Luperox in acetone
Example 9: 72.5% [80% PHBV/20% Ecoflex]/1.6% MA-g-PHBV/0.4% MA-g-Ecoflex/7.5% Talc (AG609)/5% Silane treated Wollastonite/12.5% Soy Protein Isolate/0.5% Biowax (Wax in Acetone Emulsion)/0.05 Phr Luperox in acetone
Example 10: 72.5% [70% PHBV/30% Ecoflex]/1.4% MA-g-PHBV/0.6% MA-g-Ecoflex/7.5% Talc (AG609)/5% Silane treated Wollastonite/12.5% Milk Protein Concentrate/0.5% Biowax (Wax in Acetone Emulsion)/0.05 Phr Luperox in acetone
Example 11: 73% [85% BioPBS (injection grade)+15% PLA (injection grade)]+1.7% MA-g-BioPBS (injection grade)+0.3% MA-g-PLA (injection grade)+18% Talc (AG609)+7% Soy Protein Isolate+0.02 phr Luperox
Example 12: 73% [85% BioPBS (injection grade)+15% PLA (injection grade)]+1.7% MA-g-BioPBS (injection grade)+0.3% MA-g-PLA (injection grade)+18% Talc (AG609)+7% Milk Protein Concentrate+0.02 phr Luperox
Example 13: 73% [80% BioPBS (injection grade)+20% PLA (injection grade)]+1.6% MA-g-BioPBS (injection grade)+0.4% MA-g-PLA (injection grade)+18% Talc (AG609)+7% Starch
Example 14: 71% [80% BioPBS (injection grade)+20% PLA (injection grade)]+1.6% MA-g-BioPBS (injection grade)+0.4% MA-g-PLA (injection grade)+20% Talc (AG609)+7% Starch+0.75 phr Joncryl (w.r.t whole formulation)
Example 15: 73% [80% BioPBS (injection grade)+20% PLA (injection grade)]+1.6% MA-g-BioPBS (injection grade)+0.4% MA-g-PLA (injection grade)+18% Talc (AG609)+7% Soy Protein Isolate+0.02 phr Luperox+0.75 phr Joncryl (w.r.t whole formulation)
Example 16: 73% [80% BioPBS (injection grade)+20% PLA (injection grade)]+1.6% MA-g-BioPBS (injection grade)+0.4% MA-g-PLA (injection grade)+18% Talc (AG609)+7% Milk Protein Concentrate+0.02 phr Luperox+0.75 phr Joncryl (w.r.t whole formulation)

TABLE 3
Barrier data produced using injection molded Keurig type pods and mechanical data produced using injection molded specimens
using PHBV-based composite formulations. EVOH is used as reference material for barrier and mechanical data comparison.
EVOH [Espresso Type Injection Molded Pod]

| | A | B | | C | D | | E | | |
|---|---|---|---|---|---|---|---|---|---|
| 1 | 0.44 | 0.0024 | | 0.043 | 0.0009 | | 0.036 | | |
| | F | G | H | I | J | K | L | M | N |
| | 4345 ± 131 | 72.5 ± 1.3 | 3.27 ± 0.24 | 3.27 ± 0.24 | 3915 ± 59 | 125.5 ± 2.5 | 23.23 ± 1.21 | 20 | 85.1 ± 6.7 |

PHBV-based Formulations [Keurig Type Injection Molded Pods]

| | A | B | | C | D | | E | | |
|---|---|---|---|---|---|---|---|---|---|
| 2 | 0.6 | 0.019 ± 0.0006 | | 0.459 ± 0.014 | 0.033 ± 0.002 | | 0.781 ± 0.057 | | |
| | F | G | H | I | J | K | L | M | N |
| | 3394 ± 165 | 27.4 ± 0.9 | 1.8 ± 0.01 | 2.08 ± 0.02 | 2631 ± 114 | 43.6 ± 2.6 | 26 ± 2.5 | 14 | 120.21 |
| | A | B | | C | D | | E | | |
| 3 | 0.6 | 0.021 ± 0.002 | | 0.493 ± 0.055 | — | | — | | |
| | F | G | H | I | J | K | L | M | N |
| | 2698 ± 202 | 23.5 ± 1.9 | 1.3 ± 0.05 | 1.3 ± 0.05 | 2529 ± 167 | 42 ± 4 | 25.6 ± 4.5 | 23 | 102.64 |
| | A | B | | C | D | | E | | |
| 4 | 0.6 | 0.031 ± 0.00007 | | 0.735 ± 0.001 | — | | — | | |
| | F | G | H | I | J | K | L | M | N |
| | 1798 ± 27.5 | 21 ± 1.3 | 2.06 ± 0.39 | 2.20 ± 0.53 | 2085 ± 34.04 | 34.07 ± 2.04 | 28.26 ± 0.81 | 15.1 ± 0.2 | 78.95 |
| | A | B | | C | D | | E | | |
| 5 | 0.6 | 0.024 ± 0.0007 | | 0.577 ± 0.018 | — | | — | | |
| | F | G | H | I | J | K | L | M | N |
| | 1877 ± 119.05 | 22.6 ± 0.26 | 2.24 ± 0.14 | 2.49 ± 0.23 | 2250 ± 46.21 | 41.63 ± 1.42 | 26.67 ± 0.34 | 14 ± 0.6 | 102.70 |
| | A | B | | C | D | | E | | |
| 6 | 0.58 | 0.017 ± 0.005 | | 0.393 | — | | — | | |
| | F | G | H | I | J | K | L | M | N |
| | 3693 ± 92 | 24.6 ± 0.4 | 1.04 ± 0.02 | 1.07 ± 0.04 | 3479 ± 63 | 42.5 ± 1.2 | 11.78 ± 1.33 | 26 ± 0.4 | 126.5 |
| | A | B | | C | D | | E | | |
| 7 | 0.58 | 0.003 ± 0.00005 | | 0.069 ± 0.001 | 0.016 ± 0.003 | | 0.391 ± 0.075 | | |
| | F | G | H | I | J | K | L | M | N |
| | 3894 ± 289 | 28.9 ± 0.4 | 1.28 ± 0.04 | 1.31 ± 0.08 | 3697 ± 229 | 52.0 ± 2.2 | 14.02 ± 1.11 | 16 ± 0.4 | 140.4 |
| | A | B | | C | D | | E | | |
| 8 | 0.6 | 0.008 ± 0.002 | | 0.194 ± 0.069 | — | | — | | |
| | F | G | H | I | J | K | L | M | N |
| | 3757 ± 106 | 28.1 ± 0.2 | 1.30 ± 0.03 | 1.32 ± 0.04 | 3302 ± 148 | 50.4 ± 0.9 | 12.63 ± 1.09 | 14.5 ± 1 | 135.3 |
| | A | B | | C | D | | E | | |
| 9 | 0.6 | 5.964 ± 0.0006 | | 140.891 ± 0.014 | — | | — | | |
| | F | G | H | I | J | K | L | M | N |
| | 2426 ± 129.9 | 23.5 ± 0.5 | 1.30 ± 0.09 | 1.30 ± 0.09 | 3565 ± 137.2 | 43.54 ± 2.66 | 14.22 ± 1.88 | 19 ± 0.5 | 107.81 |
| | A | B | | C | D | | E | | |
| 10 | 0.6 | 0.0129 ± 0.001 | | 0.305 ± 0.024 | — | | — | | |
| | F | G | H | I | J | K | L | M | N |
| | 2338 ± 119.26 | 27.6 ± 1.71 | 1.93 ± 0.26 | 1.99 ± 0.30 | 3201 ± 135.1 | 50.32 ± 2.17 | 27.25 ± 1.29 | 12.5 ± 1 | 134.75 |

TABLE 4
Barrier data produced using injection molded Keurig type pods and mechanical data
produced using injection molded specimens using BioPBS/PLA-based composite formulations.
BioPBS/PLA-based Formulations [Espresso Type Injection Molded Pods]

| | A | B | | C | D | | E | | |
|---|---|---|---|---|---|---|---|---|---|
| 11 | 0.67 | 0.017 ± 0.0003 | | 0.445 ± 0.008 | — | | — | | |
| | F | G | H | I | J | K | L | M | N |
| | 2049 ± 59 | 31 ± 0.1 | 6.1 ± 0.2 | 6.6 ± 0.8 | 1593 ± 83 | 46.0 ± 1.3 | 31.3 ± 2.3 | 11.3 ± 0.3 | 87 |
| | A | B | | C | D | | E | | |
| 12 | 0.6 | 0.009 ± 0.00004 | | 0.223 ± 0.001 | — | | — | | |
| | F | G | H | I | J | K | L | M | N |
| | 2171 ± 11 | 34.3 ± 0.2 | 5.2 ± 0.3 | 6.1 ± 0.4 | 1781 ± 30 | 51.3 ± 0.7 | 28.5 ± 3.6 | 12 ± 0.4 | 85.9 |
| | A | B | | C | D | | E | | |
| 13 | 0.6 | 0.015 ± 0.0003 | | 0.361 ± 0.006 | — | | — | | |
| | F | G | H | 1 | J | K | L | M | N |
| | 2476 ± 78 | 35.1 ± 0.3 | 4.8 ± 0.6 | 5.1 ± 0.7 | 1846 ± 89 | 51.1 ± 1.3 | 29.2 ± 3.2 | 19.6 ± 0.4 | 78.2 |
| | A | B | | C | D | | E | | |
| 14 | 0.67 | 0.013 ± 0.00004 | | 0.361 ± 0.001 | — | | — | | |
| | F | G | H | 1 | J | K | L | M | N |
| | 1945 ± 87.26 | 39.3 ± 0.36 | 5.22 ± 0.49 | 5.41 ± 0.43 | 2147 ± 29.01 | 58.83 ± 1.6 | 29.54 ± 1.08 | 16.9 ± 0.3 | 89.60 |
| | A | B | | C | D | | E | | |
| 15 | 0.67 | 0.013 ± 0.00003 | | 0.362 ± 0.0009 | — | | — | | |
| | F | G | H | I | J | K | L | M | N |
| | 1772 ± 78.83 | 37.6 ± 1.02 | 5.02 ± 0.16 | 5.07 ± 0.44 | 1958 ± 165.09 | 56.64 ± 3.47 | 29.93 ± 2.68 | 13.4 ± 0.4 | 85.97 |
| | A | B | | C | D | | E | | |
| 16 | 0.65 | 0.009 ± 0.001 | | 0.234 ± 0.042 | 0.0201 ± 0.00 | | 0.523 ± 0.001 | | |
| | F | G | H | I | J | K | L | M | N |
| | 1870 ± 73.49 | 39.5 ± 0.78 | 5.52 ± 0.85 | 5.72 ± 0.99 | 2040 ± 63.81 | 60.01 ± 1.36 | 27.91 ± 2.13 | 14.2 ± 0.4 | 75.74 |

### CROSS CHECKED REFERENCES

US20140373748 A1, Method for production milk protein gels, -hydrogels-, hydrocolloides, and superabsorbers (milk protein gels), Anke Domaske.
DE202004004732U1, Multi-functional biodegradable composite packaging for foods and non-foods, e.g. sausage casings, comprises a plastics outer layer; a casein derivative inner, edible layer and a hard/separation gel as the middle layer, MWB MAN WIRTSCHAFTSFOERDERUNGS Mwb Management.
WO2013068597A1, Method for producing a milk protein based plastic material (mp based plastic material), Anke Domaske.
US20210381130A1, Development of bio-composite materials for 3D printing using milk proteins, John Obielodan and Tsunghseh Wu.
US20230192983, Compostable Oxygen Barrier Comprising a Biodegradable Polymer Matrix and Biocarbon, Mohanty et al.

Although various embodiments of the disclosure have been described and illustrated, it will be apparent to those skilled in the art in light of the present description that numerous modifications and variations can be made. The scope of the invention is defined more particularly in the appended claims.

What is claimed is:

1. A gas barrier substrate, wherein the gas barrier substrate comprises a biodegradable composite, the biodegradable composite comprising a polymeric matrix and a sustainable filler comprising protein.

2. The gas barrier substrate of claim 1, wherein the biodegradable composite has an oxygen transmission rate of 55 cc/m2-day or less, or an oxygen transmission rate of 5.96 cc/pkg·day or less, or an oxygen transmission rate of 0.031 cc/pkg·day or less, or an oxygen transmission rate of 0.013 cc/pkg·day or less, or an oxygen transmission rate of 0.009 cc/pkg·day or less, or an oxygen transmission rate of 0.003 cc/pkg·day or less, wherein the oxygen transmission rate is calculated at normalized thickness of the biodegradable composite of 25.4 micrometer (1 mil) at 0% relative humidity, 23.7° C.

3. The gas barrier substrate of claim 1, wherein the biodegradable composite has a water permeation rate of 0.033 g/pkg·day, or less or has a water permeation rate of 0.02 g/pkg·day or less, or a water permeation rate of 0.016 g/pkg·day or less, wherein the water permeation rate is calculated at normalized thickness of the biodegradable composite of 25.4 micrometer (1 mil) at 100% relative humidity, 37.8° C.

4. The gas barrier substrate of claim 1, wherein the polymeric matrix comprises one or more biodegradable polymers.

5. The gas barrier substrate of claim 4, wherein the polymer matrix comprises one or more of polylactide (PLA), Bio-based poly(butylene succinate) (BioPBS), poly(butylene succinate adipate) (PBSA), poly(butylene adipate-co-terephthalate) (PBAT), polycaprolactone (PCL), polyhydroxyalkanoates (PHAs) including poly(3-hydroxy) butyrate (PHB) and poly(3-hydroxybutyrate-hydroxyvalerate) (PHBV).

6. The gas barrier substrate of claim 4, wherein the polymeric matrix comprises a binary blend of PHBV/PBAT, BioPBS/PLA, or a ternary blend of PHBV/PBAT/PBSA.

7. The gas barrier substrate of claim 1, wherein the polymeric matrix comprises PHBV, BioPBS, PBSA, PBAT, PCL or PLA as a major component of the polymeric matrix.

8. The gas barrier substrate of claim 1, wherein the biodegradable composite is free of ethylene vinyl alcohol (EVOH) or polyvinyl alcohol (PVOH).

9. The gas barrier substrate of claim 1, wherein the sustainable filler is a hybrid filler comprising (a) milk protein and/or soy protein and (b) a second filler selected from one or more of: starch; inorganic mineral fillers from talc, clay and/or wollastonite.

10. The gas barrier substrate of claim 1, wherein the biodegradable composite comprises up to 25 wt % of sustainable fillers.

11. The gas barrier substrate of claim 1, wherein the oxygen transmission rate of the gas barrier substrate is similar or lower than the oxygen transmission rate of each one of PET, Nylon or EVOH.

12. The gas barrier substrate of claim 1, wherein the biodegradable composite further comprises a compatibilizer, the compatibilizer including peroxide or maleic anhydride-grafted biopolymers.

13. The gas barrier substrate of claim 1, wherein the gas barrier substrate is industrial compostable or home compostable.

14. The gas barrier substrate of claim 1, wherein the gas barrier substrate is a single layer gas barrier.

15. The gas barrier substrate of claim 1, wherein the gas barrier substrate is in the form of a pellet, a granule, an extruded solid, an injection molding solid.

16. An article of manufacture comprising the gas barrier substrate of claim 1.

17. The article of manufacture of claim 16, wherein the article of manufacture is a film, sheet, membrane, injection molded or thermoformed shapes.

18. The article of manufacture of claim 16, wherein the article of manufacture is a packaging in shape of a coffee pod.

19. A method of limiting gas permeation through a membrane, the method comprising at least partially or entirely manufacturing the membrane with the gas barrier substrate of claim 1.

20. The method of claim 19, wherein the membrane is in the form of a container.
